(19) United States
(12) Patent Application Publication
(10) Pub. No.: US 2011/0038137 A1
(43) Pub. Date: Feb. 17, 2011

(54) LIGHT GUIDING BODY AND DISPLAY DEVICE USING THE SAME

(75) Inventors: Kohki Ishikawa, Tokyo (JP); Kiyotsugu Oba, Tokyo (JP); Mitsuru Kamikatano, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJIKURA LTD., Tokyo (JP)

(21) Appl. No.: 12/988,161

(22) PCT Filed: Apr. 16, 2009
(86) PCT No.: PCT/JP2009/057693

§ 371 Date: Oct. 15, 2010

(30) Foreign Application Priority Data
Apr. 17, 2008 (JP) 2008-108218

(51) Int. Cl. G01D 11/28

(52) U.S. Cl. 362/23

(57) ABSTRACT

Light emitted from light sources is reflected toward a dial plate by reflecting surfaces of a plurality of grooves radially formed on a light guide body from the center position of the light guiding body which is arranged on the rear surface side of the dial plate and has a circular arc shape in plane view. Then, the reflected light is diffused by a light diffusion film, and the diffused light transmissively illuminates a scale marks section and a numerical characters section of the dial plate.

### BACKGROUND OF THE INVENTION

1. Technical Field of the Invention

The present invention relates to a light guide body to be used for a speedometer, a tachometer and other display devices of vehicles.

A display device used as an indicator for vehicles has scale marks and/or numerical characters arranged in a circular arc fashion, for example, along the rotation of a pointer and at the outer circumference of a dial plate. A plurality of light sources may also be arranged in a circular arc fashion behind the scale marks and/or numerical characters thereby transmissively illuminating them.

In order for less light sources to transmissively illuminate a dial plate in homogeneous illumination, there is proposed a technique using a light-transmissive light guide body provided behind the dial plate, which guides light from light sources to the dial plate thereby transmissively illuminating the dial plate (Patent Document 1).

[Patent Document 1] Japanese Patent Application Publication (Kokai) 2007-139791

### SUMMARY OF THE INVENTION

The above-described Patent Document 1 discloses a display device in which light beams from two light source are combined to form combined light and the surface of the light guide body is illuminated by the combined light. However, regarding the illuminating region of the surface of the light guide body, the same luminance is not necessarily obtained at regions different in the combining proportion of the light beams from the two light sources, and as such ununiformity of luminance occurs in the illuminating region.

The object of the present invention is to provide a light guide body to suppress the occurrence of ununiformity of luminance at a dial plate and a display device using the light guide body.

A light guide body for a display device according to the present invention is located at a rear surface side of a light-transmissive dial plate having an indicative section arranged in a circular arc fashion such that the light guide body covers the indicative section. The light guide body is formed in a circular arc shape and has at least one end face to which light from a light source is incident. The light guide body is characterized by that the light guide body has a first main surface that faces the dial plate and a second main surface that is an opposite surface of the first main surface, the second main surface is formed with a plurality of groove regions radially from a center position of the circular arc shaped light guide body, and each of the plurality of groove regions has a reflecting surface for reflecting light from the light source to a side of the first main surface of the light guide body.

In the above-described light guide body for a display device, the reflecting surface may be configured as a slanted face of a V-shaped groove region formed at the second main surface.

Also in the above-described light guide body for a display device, the groove region may be configured as a groove continuously formed in a width direction of the light guide body.

Also in the above-described light guide body for a display device, the groove region may be formed across the width direction of the light guide body.

Also in the above-described light guide body for a display device, the V-shaped groove region may be formed such that a depth thereof increases in accordance with an increase of a distance from the light source.

Also in the above-described light guide body for a display device, the light guide body may be configured such that light from a first light source is incident to one end face of the light guide body, and light from a second light source different from the first light source is incident to an other end face of the light guide body.

Also in the above-described light guide body for a display device, the reflecting surface of each groove region may be formed such that the reflecting surface reflects light from either one of the first light source and the second light source, which is relatively close to the reflecting surface in a distance via the light guide body, toward the first main surface.

Further, the above-described light guide body for a display device may be used for a display device which comprises: a light-transmissive dial plate having an indicative section arranged in a circular arc fashion; and a light diffusion member located between the light guide body and the dial plate and diffusing light emitted from the first surface of the light guide body.

In the above-described display device, the indicative section may be configured of a scale marks section comprising a plurality of scale marks arranged in a circular arc fashion and a numerical characters section comprising a plurality of numerical characters arranged in a circular arc fashion and concentrically with the scale marks section.

According to the present invention, because light from the light source is reflected by the reflecting surface of each groove region and thereafter reaches the first main surface side of the light guide body, it is enabled to suppress the occurrence of ununiformity of luminance at a dial plate.

### BRIEF DESCRIPTION OF DRAWINGS

FIG. 1 is a plan view illustrating a display device to which an embodiment of the present invention is applied;

FIG. 2A is an exploded perspective view illustrating the display device shown in FIG. 1;

FIG. 2B is a fragmentary view taken in the direction of the arrows 2B-2B in FIG. 2A;

FIG. 3 is a plan view illustrating a light guide body shown in FIG. 1;

FIG. 4 is a partial perspective view illustrating the light guide body shown in FIG. 3;

FIG. 5A is a partial sectional view illustrating one groove region of the light guide body shown in FIG. 3; and

FIG. 5B is a partial sectional view illustrating groove regions of the light guide body shown in FIG. 3.

### DESCRIPTION OF THE PREFERRED EMBODIMENT

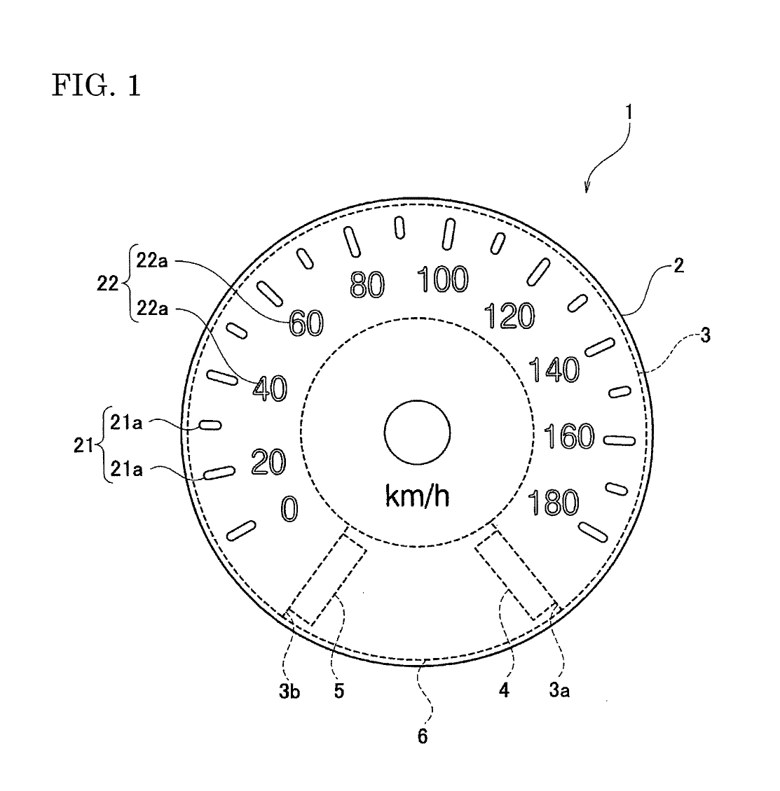

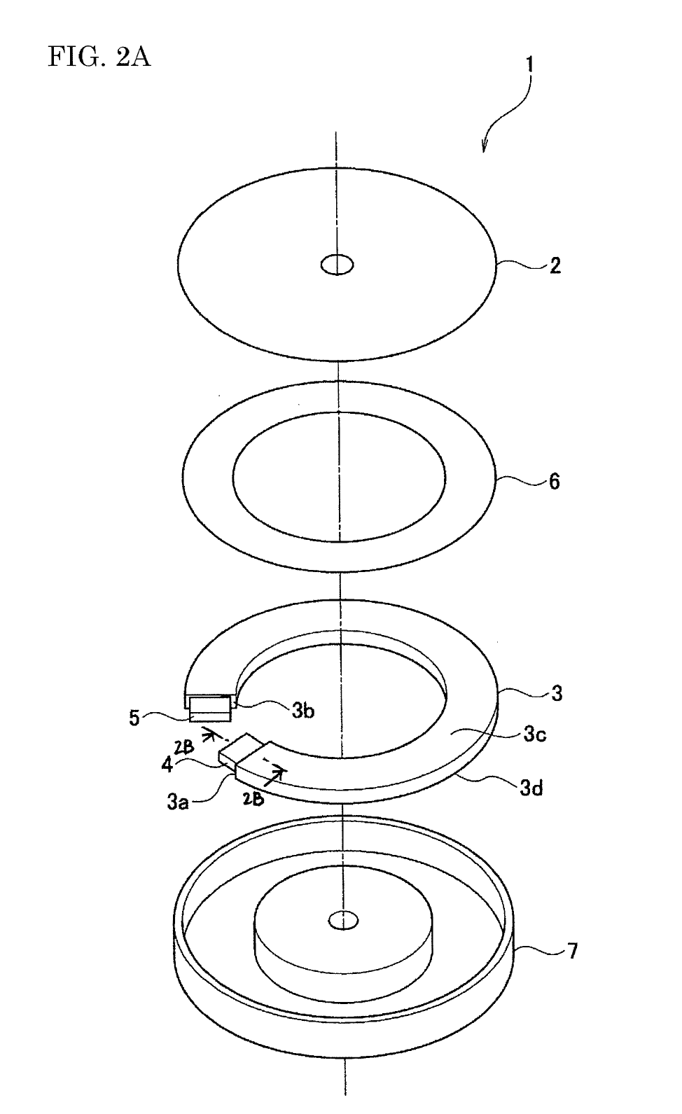

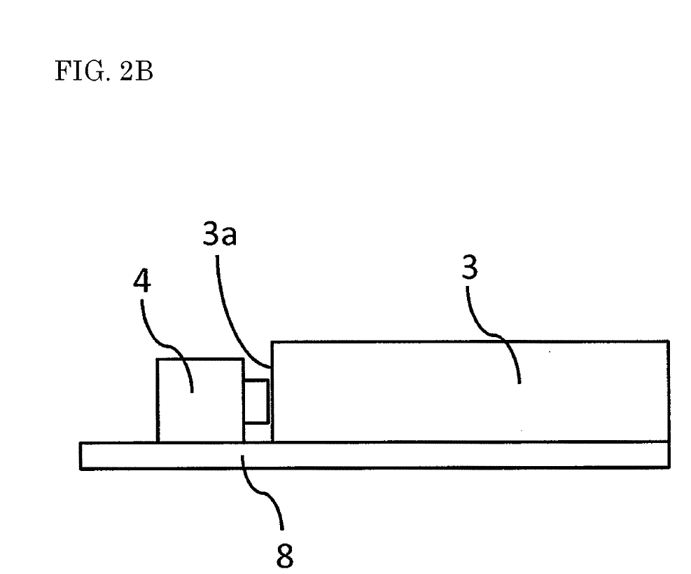

FIG. 1 and FIG. 2 depict an example in which an embodiment of the present invention is applied to a speedometer as a display device for a motor vehicle. As shown in FIG. 1 and FIG. 2, a display device 1 according to the present embodiment comprises a dial plate 2, a light guide body 3, light sources 4 and 5, a light diffusion film 6, and a case 7.

The dial plate 2 shown in FIG. 1 is formed of a thin plate of light-transmissive material, such as acrylic resin and polycarbonate resin. The dial plate 2 is formed with a scale marks section 21 which comprises a plurality of scale marks 21a arranged in a circular arc fashion and a numerical characters section 22 which is allocated at inner area of the scale marks section 21 and comprises a plurality of numerical characters 22a also arranged in a circular arc fashion and concentrically with the scale marks section 21. In the present embodiment, the scale marks section 21 and numerical characters section 22 are also collectively referred to as an indicative section.

The scale marks section 21 and numerical characters section 22 are formed by performing printing, hot stamping, or the like on the front surface or the rear surface of the dial plate 2. More specifically, a colored layer having a light-intransmissivity is provided on an area other than the scale marks section 21 and numerical characters section 22, and the scale marks section 21 and numerical characters section 22 remain transparent or are treated with a semi-transparent layer and the like. It is to be noted that the front surface of dial plate 2 is intended to mean a main surface capable of being visually recognized by a user in the status where the dial plate 2 is incorporated into a speedometer while the rear surface of dial plate 2 is intended to mean the opposite main surface.

The light guide body 3 is formed of a light-transmissive plastic material, such as transparent acrylic resin, polycarbonate resin, silicone resin, cyclo-polyolefin resin, and the like, in a plate-like form with thickness of approximately 1 mm to 3 mm, for example. As shown in FIG. 1 and FIG. 2, the light guide body 3 is formed as a circular arc shape with a certain width in plane view and located at the rear surface side of the dial plate 2 so as to cover the scale marks section 21 and numerical characters section 22. In addition, entrance faces 3a and 3b to be respective entrances for light beams from the light sources 4 and 5 are provided at both end portions of the light guide body 3 corresponding to the both ends of the circular arc shape.

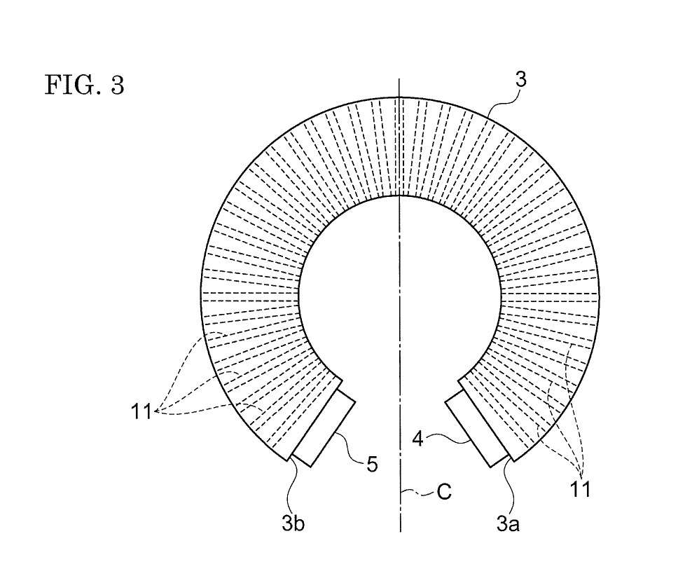

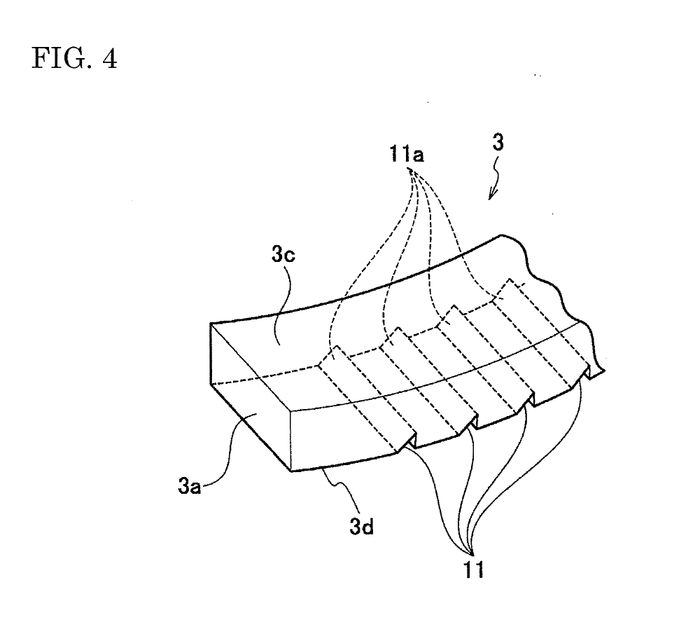

In turn, as shown in FIG. 3 and FIG. 4, a plurality of groove regions 11 are formed radially from the center position 0 of the circular arc shape in plane view of the light guide body 3, almost entirely in the circumferential direction thereof, and in predetermined angular intervals on a second main surface 3d of the light guide body 3, which is the opposite surface of a first main surface 3c facing the dial plate 2. Each groove region 11 has an approximately V-shaped cross section and is formed across the width direction of light guide body 3. The predetermined angular intervals may be designed as two degrees, for example.

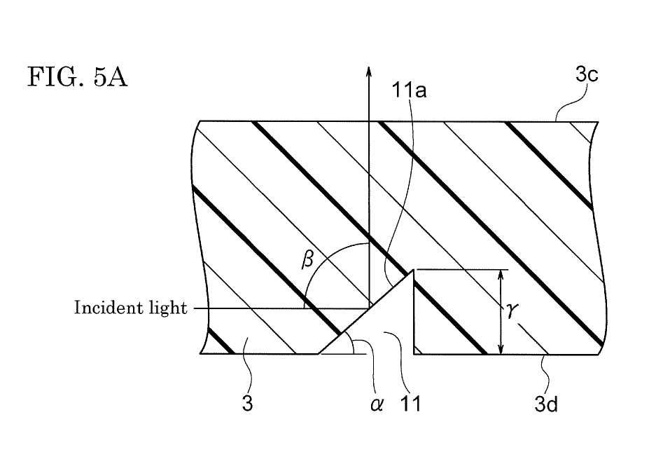

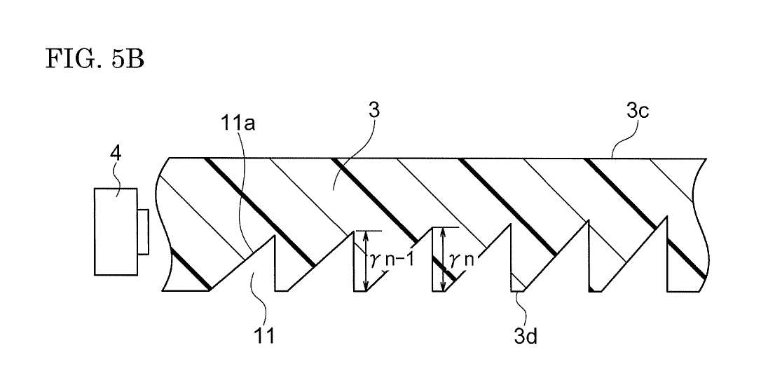

As shown in FIG. 4, a reflecting surface 11a is formed on one face of each groove region 11 across the width direction of light guide body 3. The reflecting surface 11a is to reflect the light propagating in light guide body 3 toward the surface 3c side, and is structured as a slanted face inclined at a predetermined inclination angle of a relative to the second main surface 3d, as shown in FIG. 5A. By forming the reflecting surfaces 11a of groove regions 11 across the width directions of light guide body 3, ununiformity of light emitting luminance on the dial plate 2 can be suppressed from occurring.

Each reflecting surface 11a is formed such that light from either one of the light sources 4 and 5 is reflected toward the first main surface 3c side of light guide body 3. For example, each of the groove regions 11 arranged at the light source 4 side relative to the center line C shown in FIG. 3 (the right-hand side shown therein) is formed such that the reflecting surface 11a faces toward the light source 4, which is a light source relatively close to that groove region 11 in a distance via light guide body 3, and reflects light from the light source 4 toward the first main surface 3c, while each of the groove regions 11 arranged at the light source 5 side relative to the center line C shown in FIG. 3 (the left-hand side shown therein) is formed such that the reflecting surface 11a faces toward the light source 5, which is a light source relatively close to that groove region 11 in a distance via light guide body 3, and reflects light from the light source 5 toward the first main surface 3c.

If the inclination angle α of reflecting surface 11a is too small, then the inclination angle β of the reflected light becomes to be large, thereby deteriorating the light emitting luminance at the time the dial plate 2 is squarely viewed. In contrast, if the inclination angle a is too large, then the incident angle of light exceeds the critical angle, thereby increasing the proportion of light transmitting through the reflecting surface 11a, decreasing the reflection efficiency, and deteriorating utilization efficiency of light.

In order to suppress such a deterioration of utilization efficiency of light, there is known a method where the emitting luminance is heightened by increasing the input power to the light sources 4 and 5. However, this method is not preferred because of causing an increase in power consumption and/or deterioration in lifetime of the light sources 4 and 5. Given the foregoing, the inclination angle a of the reflecting surface 11a is preferably in the range of 45 degrees to 60 degrees, and more preferably in the range of 50 degrees to 55 degrees. By setting the inclination angle a within such ranges, the reflection efficiency of light can be increased and the emitting luminance of the dial plate 2 can also be increased.

Meanwhile, in the case where the reflecting surfaces 11a have the same inclination angle α, if heights (or depths) of whole the groove regions 11 are the same as being γ (refer to FIGS. 5A and 5B), then the luminance of the reflected light from the groove region 11 located far from the light sources 4 and 5 is liable to be lower than that of the reflected light from the groove region 11 located near the light sources 4 and 5. Consequently, in the present embodiment, the larger the distance from the light source 4 to each groove region 11 arranged at the light source 4 side (the right-hand side in FIG. 3) is, the larger the height γ is set, as shown in FIG. 5B, while the larger the distance from the light source 5 to each groove region 11 arranged at the light source 5 side (the left-hand side in FIG. 3) is, the larger the height γ is set. This allows the reflected light quantity from each groove region 11 to be even, thereby enabling to obtain homogeneity in luminance. In other words, by providing a balance between that the light quantity decreases by attenuation in accordance with the increase in distance from the light source 4 or 5 and that the luminance of the reflected light is to be increased by stepwisely increasing the height γ in accordance with the increase in distance from the light source 4 or 5, the luminance within the relevant region may be even.

Although the production method of the light guide body 3 is not particularly limited, the light guide body 3 formed with groove regions 11 is easily produced through metal molding and/or diamond bite cutting, possibly with cutting by heated edge, for example.

The light sources 4 and 5, each of which comprises one or more light emitting diodes, laser diodes and the like, are arranged such that the respective light beams from light sources 4 and 5 are capable of being incident to the entrance faces 3a and 3b, respectively. For example, the light sources 4 and 5 are each constituted as two light emitting diodes arranged in directions along the entrance faces 3a and 3b, respectively. Note that numeral reference 8 denotes a printed wiring board on which the light source 4 provided as a light emitting diode is mounted, as shown in FIG. 2B, while the printed wiring board 8 is omitted to be illustrated in FIG. 2A.

The light diffusion film 6, which comprises a resin diffusing light or a film coated with such a resin, is formed in an annular shape in plane view or in a circular arc shape in plane view. The light diffusion film 6 is located on the surface 3c of light guide body 3 to diffuse light emitted from the surface 3c.

The case 7 accommodates and holds the above-described components. The printed wiring board 8 for being mounted with the light sources 4 and 5 and a movement to drive a pointer is also accommodated and held in the case 7.

Although the speedometer is provided with a pointer for pointing to the scale mark 21a of the dial plate 2 and a movement for rotating the pointer, etc, such parts are omitted to be depicted and explained because of not directly relating to the present invention.

Given the above structure of display device 1, when the light sources 4 and 5 are supplied with electric power from external to emit light beams, the light guide body 3 receives respective light beams at the entrance faces 3a and 3b, and the received light beams propagate within the light guide body 3 while being reflected between the first main surface 3c, the second main surface 3d and side surfaces of the light guide body 3. In turn, as the light beams propagate within the light guide body 3, almost the whole of light arrived at the reflecting surfaces 11a of the groove regions 11 is reflected by the reflecting surfaces 11a thereby being emitted from the first main surface 3c side to external space, as shown in FIG. 5A.

The light emitted from the first main surface 3c of light guide body 3 after being reflected by each reflecting surface 11a of the groove regions 11 is diffused by the light diffusion film 6. This diffused light, which has homogeneous luminance at the relevant area, transmissively illuminates the scale marks section 21 and numerical characters section 22 of the dial plate 2 thereby providing luminescent display.

According to the present embodiment, the light from light sources 4 and 5 is reflected toward the dial plate 2 side by the plurality of reflecting surfaces 11a of the groove regions 11 formed on the light guide body 3 and radially from the center position thereof, and the reflected light is diffused by the light diffusion film 6 thereby providing homogeneous luminance at the relevant area. Therefore, it is enabled to transmissively illuminate the scale marks section 21 and numerical characters section 22 of the dial plate 2 with uniform brightness, and to suppress ununiformity of light emitting luminance of the scale marks section 21 and numerical characters section 22 on the dial plate 2 from occurring, thereby improving visibility of the display device 1.

In addition, the light guide body 3 may be produced through a simple fabrication such as a metallic molding because the design and fabrication of each face is unnecessary.

Although the light guide body 3 is formed as being circular arc shape with certain width in plane view in response that the dial plate 2 is formed as being circular arc shape in the above-described embodiment, the light guide body according to the present invention is not limited to being circular arc in a district sense. It is appreciated that the light guide body would be applied on a merely bent or curved shape.

According to the above-described embodiment, the groove regions 11 are formed radially from the center point of the circular arc shaped light guide body 3, because the light guide body 3 is in a circular arc shape and the light sources 4 and 5 are each located at the center of the width direction of the light guide body 3. Alternatively, in the case where the light guide body 3 is not in a circular arc shape but in a merely bent or curved shape, or the light sources 4 and 5 are each located as being deviated away from the center of the width direction of the light guide body 3, it is preferred that the groove regions 11 are formed at positions and in directions as guiding light from the light sources 4 and 5 to propagate along the shape of the light guide body 3.

### INDUSTRIAL APPLICABILITY

The light guide body according to the present invention is capable of being utilized for a speedometer, a tachometer and other display devices of vehicles.

### DESCRIPTION OF REFERENCE NUMERALS

1; display device
2; dial plate
3; light guide body
3a, 3b; entrance faces
3c; first main surface
3d; second main surface
4, 5; light sources
6; light diffusion film
7; case
8; printed wiring board
11; groove regions
11a; reflecting surfaces
21; scale marks section
21a; scale marks
22; numerical characters section
22a; numerical characters

What is claimed is:

1. A light guide body for a display device, the light guide body being located at a rear surface side of a light-transmissive dial plate having an indicative section arranged in a curved fashion such that the light guide body covers the indicative section, the light guide body being formed in a curved shape and having at least one end face to which light from a light source is incident, wherein
the light guide body has a first main surface that faces the dial plate and a second main surface that is an opposite surface of the first main surface, the second main surface is formed with a plurality of groove regions so as to guide light from the light source along the curved shape of the light guide body, and each of the plurality of groove regions has a reflecting surface for reflecting light from the light source to a side of the first main surface of the light guide body.

2. The light guide body for a display device as recited in claim 1, wherein
the light guide body is located at the rear surface side of the light-transmissive dial plate having the indicative section arranged in a circular arc fashion such that the light guide body covers the indicative section,
the light guide body is formed in a circular arc shape, and
the plurality of groove regions are formed radially from a center position of the circular arc shaped light guide body.

3. The light guide body for a display device as recited in claim 2, wherein
the reflecting surface is a slanted face of a V-shaped groove region formed at the second main surface.

4. The light guide body for a display device as recited in claim 3, wherein
the groove region is a groove continuously formed in a width direction of the light guide body.

5. The light guide body for a display device as recited in claim 4, wherein
the groove region is formed across the width direction of the light guide body.

6. The light guide body for a display device as recited in claim 3, wherein
the V-shaped groove region is formed such that a depth thereof increases in accordance with an increase of a distance from the light source.

7. The light guide body for a display device as recited in claim 2, wherein
light from a first light source is incident to one end face of the light guide body, and
light from a second light source different from the first light source is incident to an other end face of the light guide body.

8. The light guide body for a display device as recited in claim 7, wherein
the reflecting surface of each groove region is formed such that the reflecting surface reflects light from either one of the first light source and the second light source, which is relatively close to the reflecting surface in a distance via the light guide body, toward the first main surface.

9. A display device comprising:
a light-transmissive dial plate having an indicative section arranged in a circular arc fashion;
the light guide body for a display device as recited in either one of claims 1 to 8; and
a light diffusion member located between the light guide body and the dial plate and diffusing light emitted from the first surface of the light guide body.

10. The display device as recited in claim 9, wherein
the indicative section has a scale marks section comprising a plurality of scale marks arranged in a circular arc fashion and a numerical characters section comprising a plurality of numerical characters arranged in a circular arc fashion and concentrically with the scale marks section.
